(19) United States
(12) Patent Application Publication
(10) Pub. No.: US 2019/0266618 A1
(43) Pub. Date: Aug. 29, 2019

(54) DATA MANAGEMENT APPARATUS AND DATA MANAGEMENT SYSTEM

(71) Applicant: Hitachi, Ltd., Tokyo (JP)

(72) Inventors: Akihito MIZOE, Tokyo (JP); Mari KUWAHARA, Tokyo (JP); Go SHINOHARA, Tokyo (JP)

(21) Appl. No.: 16/122,910

(22) Filed: Sep. 6, 2018

(30) Foreign Application Priority Data
Feb. 23, 2018 (JP) 2018-031311

(51) Int. Cl. G06Q 30/02; G06F 17/30

(52) U.S. Cl. CPC G06Q 30/0201; G06F 17/30876

(57) ABSTRACT

A data management apparatus and a data management system include a relative time conversion unit which, for a purchase history of a model customer who has achieved a higher rank by satisfying a predetermined condition, takes the time the rank was achieved as a reference time and converts times in each purchase history to relative times and which, for a purchase history of a target customer who has not attained the rank, takes the time when an analysis target is designated as a reference time, and converts times in each purchase history to relative times, and a behavior history analysis unit which determines whether a behavior history of the target customer is included in a behavior history of the model customer, based on each relative time of the behavior history and each relative time of the behavior history with which each purchase history of the target customer has been associated.

### TECHNICAL FIELD

The present invention relates to a data management apparatus and data management system and, for instance, may be suitably applied to a data management apparatus and data management system which determine whether a behavior history of a target customer is included in a model customer behavior history.

### BACKGROUND ART

We are living in an era when customer purchase behavior data can be acquired through the widespread use of membership cards and IC (Integrated Circuit) cards and the like. For B2C (Business to Consumer) enterprises, there is now an urgent need for a deeper understanding of customers and more effective measures based on data, in pursuit of increased sales, improved customer satisfaction and point of sale creation.

For example, there is a demand for presenting measures that are directed toward achieving KPIs (Key Performance Indicators) such as increased sales using purchase histories (POS: Point of Sales). It is preferable to take a suboptimal customer segment or general customer as a target and, in order to raise the rank of the customer segment to optimal, present measures such as recommending a product that is supported by an optimal customer segment with timing that is close to the behavioral characteristics of the optimal customer segment.

To this end, a customer analysis system, capable of grasping the transition of a customer rank over time from customer purchase performance data and the like, and of performing analysis to enable more effective sales promotion to the customer, is disclosed (see PTL 1).

### CITATION LIST

### Patent Literature

[PTL 1] Japanese Laid-Open Patent Application Publication No. 2002/117212

### SUMMARY OF THE INVENTION

### Problems to be Solved by the Invention

In the customer analysis system according to PTL 1, a customer list of a specific rank in a specific month is saved, mapped to a decile analysis result for the previous month, and a customer who has made a rank transition can be extracted and visualized; however, no consideration is given to a chronological behavior history and so forth. In other words, there is a problem in that it is not possible to incorporate, in any measure plan, a chronological behavior history which indicates the process by which a current optimal customer achieved a higher rank or what served as the trigger for the higher rank.

The present invention was devised in view of the foregoing points and an object of this invention is to propose a data management apparatus and data management system which make it possible to chronologically analyze the behavior history of a model customer and the behavior history of a target customer.

### Means to Solve the Problems

In order to achieve the foregoing object, the present invention is configured by comprising a relative time conversion unit which, for a purchase history of a model customer who has achieved a higher rank by satisfying a predetermined condition, takes the time the rank was achieved as a reference time and converts times in each purchase history to relative times and which, for a purchase history of a target customer who has not attained the rank, takes the time when an analysis target is designated as a reference time, and converts times in each purchase history to relative times, and a behavior history analysis unit which determines whether a behavior history of the target customer is included in a behavior history of the model customer, based on each relative time of the behavior history with which each purchase history of the model customer has been associated and each relative time of the behavior history with which each purchase history of the target customer has been associated.

According to the foregoing configuration, when it is assumed that customers of a similar age who possess similar habits and tastes, and so forth, for example, will adopt similar behaviors, by chronologically comparing the behavior history of an optimal customer serving as a model with the behavior history of a suboptimal or general customer serving as a target, it is possible to grasp a more closely fitting behavior history, support measure planning for the target customer, and adopt effective measures.

### Advantageous Effects of the Invention

According to the present invention, the behavior history of a model customer and the behavior history of a target customer can be chronologically analyzed.

### BRIEF DESCRIPTION OF DRAWINGS

FIG. 1 is a diagram showing an example of a configuration of a data management system according to a first embodiment.

FIG. 2 is a diagram showing an example of a customer master history table according to the first embodiment.

FIG. 3 is a diagram showing an example of a group extraction management table according to the first embodiment.

FIG. 4 is a diagram showing an example of a model group reference period table according to the first embodiment.

FIG. 5 is a diagram showing an example of a purchase history table according to the first embodiment.

FIG. 6 is a diagram showing an example of a model group purchase history table according to the first embodiment.

FIG. 7 is a diagram showing an example of an aggregation rule management table according to the first embodiment.

FIG. 8 is a diagram showing an example of a post-aggregation model group purchase history table according to the first embodiment.

FIG. 9 is a diagram showing an example of a segmentation rule management table group according to the first embodiment.

FIG. 10 is a diagram showing an example of a model group behavior history table according to the first embodiment.

FIG. 11 is a diagram showing an example of a target group reference period table according to the first embodiment.

FIG. 12 is a diagram showing an example of a target group purchase history table according to the first embodiment.

FIG. 13 is a diagram showing an example of a target group behavior history table according to the first embodiment.

FIG. 14 is a diagram showing an example of a behavior history comparison scoring management table according to the first embodiment.

FIG. 15 is a diagram showing an example of a model group path management table according to the first embodiment.

FIG. 16 is a diagram showing an example of a target group path management table according to the first embodiment.

FIG. 17 is a diagram showing an example of process steps relating to processing for extracting a model group purchase history according to the first embodiment.

FIG. 18 is a diagram showing an example of process steps relating to processing for aggregating purchase histories of the model group purchase history table according to the first embodiment.

FIG. 19 is a diagram showing an example of process steps relating to processing for segmenting purchase histories of the post-aggregation model group purchase history table according to the first embodiment.

FIG. 20 is a flowchart showing an example of process steps relating to processing for extracting a target group purchase history according to the first embodiment.

FIG. 21 is a diagram showing an example of process steps relating to processing for visualizing a behavior history according to the first embodiment.

FIG. 22 is a diagram showing an example of process steps relating to processing for comparing a model group behavior history with a target group behavior history according to the first embodiment.

FIG. 23 is a diagram showing an example of visualization of a model group behavior history according to the first embodiment.

FIG. 24 is a diagram showing an example of visualization of a target group behavior history according to the first embodiment.

FIG. 25 is a diagram showing an example of visualization of a comparison result comparing a model group behavior history with a target group behavior history according to the first embodiment.

### DESCRIPTION OF EMBODIMENTS

An embodiment of the present invention will now be explained in detail with reference to the appended drawings.

### (1) First Embodiment

In this embodiment, a purchase history up to the point where a customer of an optimal customer segment became an optimal customer (including various information relating to behaviors when the customer obtained articles) is matched to a part of the current purchase history of a customer of a non-optimal customer rank (a suboptimal customer or general customer, and the like), and the history which served as the trigger for the customer becoming optimal (achieving a higher rank) is extracted. Moreover, in this embodiment, when the history is simple and there is no match, a match is obtained by aggregating and/or segmenting data of purchase history-related items (product, time, and the like). According to the foregoing configuration, in addition to supporting the visualization and analysis of extracted histories, it is possible, by extracting the histories and multiplying the histories with other data to analyze same, to support measure planning that conforms to a customer in a non-optimal customer segment and take effective measures.

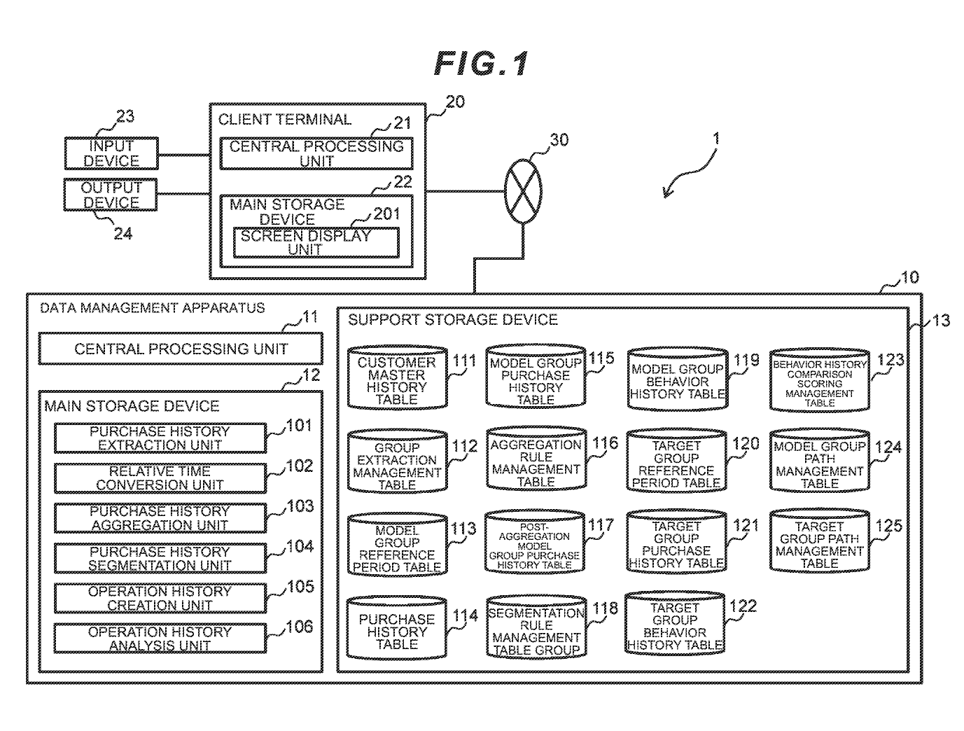

In FIG. 1, 1 denotes the overall data management system according to this embodiment. The data management system 1 comprises all or a portion of the characteristics (A) to (G) shown hereinafter, for example.

(A) In measure planning, not only purchase history data of a certain point in time, but also purchase history data which is close to the purchase behaviors of a target customer, are presented.

(B) The purchase history up to the point in time when a customer of an optimal customer segment became an optimal customer is taken as a model, and the current purchase history of a customer of a non-optimal customer segment is taken as a target.

(C) Because sometimes a match is not obtained by using only a simple purchase history, a match is obtained by aggregating and/or segmenting purchase history-related items (for example, products and/or times).

(D) The purchase history comparison method is not a simple chronological comparison, rather, a comparison is made by taking a behavior history in which times in a purchase history (year and month, for example) are given a relative value, and shifting the times of the target behavior history by taking a model behavior history as a reference.

(E) By obtaining a partial match while comparing the behavior histories of the model and target, the behavior history when the model achieved a higher rank is extracted.

(F) The extracted behavior history is, from the perspective of the model, previous data; however, from the perspective of the target, the extracted behavior history is future data which indicates behaviors that may be adopted in the future.

(G) In addition to supporting visualization and analysis of behavior histories, by extracting these histories and analyzing the histories by multiplying same with other data, it is possible to take effective measures by grasping the trigger for the higher customer rank.

This data management system 1 is configured by comprising a data management apparatus 10 and a client terminal 20. This data management apparatus 10 and client terminal 20 are communicably connected via a network 30.

The data management apparatus 10 is, for instance, a computer such as a notebook computer or a server apparatus and is configured by comprising a central processing unit 11, a main memory device 12, an auxiliary memory device 13, and a communication device which is omitted from the drawings.

The central processing unit 11 is, for instance, a CPU (Central Processing Unit) and performs various arithmetic operations. The main memory device 12 is, for instance, a RAM (Random-Access Memory) and stores various information. The auxiliary memory device 13 is a ROM (Read Only Memory), a HDD (Hard Disk Drive) or an SSD (Solid State Drive), and the like, and stores various information. Note that the communication device is configured from an NIC (Network Interface Card), for example, and performs protocol control during communication with the client terminal 20.

The functions of the data management apparatus 10 (a purchase history extraction unit 101, a relative time conversion unit 102, a purchase history aggregation unit 103, a purchase history segmentation unit 104, a behavior history creation unit 105, and a behavior history analysis unit 106, and the like), and may be realized by the central processing unit 11 reading a program which is stored in the auxiliary memory device 13 to the main memory device 12 and executing the program (software), may be realized by hardware such as a dedicated circuit, or may be realized by a combination of hardware and software. Moreover, a portion of the functions of the data management apparatus 10 could also be realized by another computer that is capable of communicating with the data management apparatus 10.

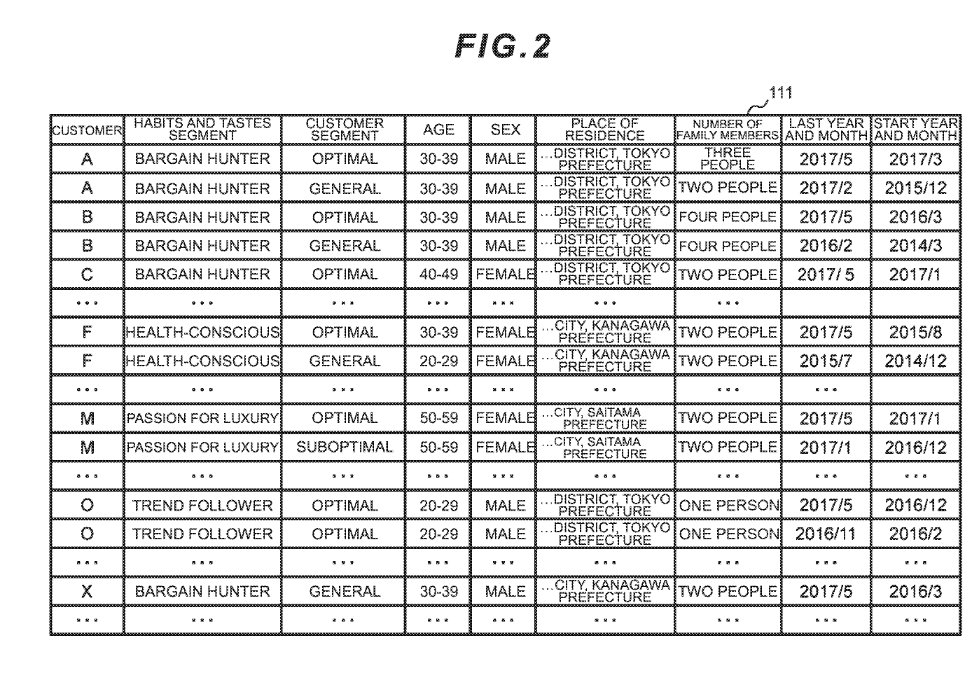

The auxiliary memory device 13 stores a customer master history table 111, a group extraction management table 112, a model group reference period table 113, a purchase history table 114, a model group purchase history table 115, an aggregation rule management table 116, a post-aggregation model group purchase history table 117, a segmentation rule management table group 118, a model group behavior history table 119, a target group reference period table 120, a target group purchase history table 121, a target group behavior history table 122, a behavior history comparison scoring management table 123, a model group path management table 124, and a target group path management table 125. The foregoing tables indicate configurations which are stored in the auxiliary memory device 13, but are not limited to such configurations, rather, all or a portion of the foregoing tables could also be stored in the main memory device 12 or could be stored in another computer which is capable of communicating with the data management apparatus 10. Note that the details of each table are explained using FIGS. 2 to 16.

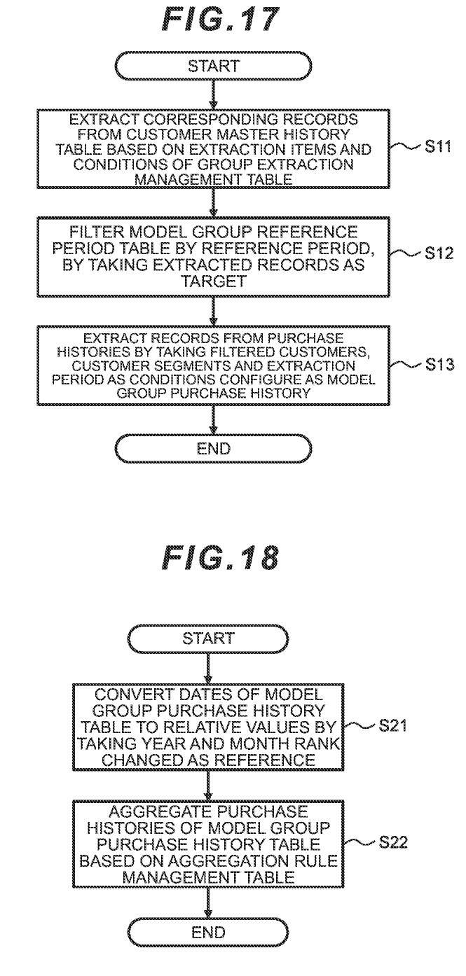

The purchase history extraction unit 101 specifies a model customer, who has achieved a higher rank as a result of satisfying predetermined conditions and serves as an analysis target (processing target), and a target customer who has not achieved this rank and extracts the purchase history from the purchase history table 114 for the specified model customer and target customer. Note that an example of the processing of the purchase history extraction unit 101 will be described hereinafter with reference to FIG. 17 and the like.

The relative time conversion unit 102 takes the time, in the purchase history, when the model customer achieved a higher rank as a reference time (a reference month, for instance), and converts the times in each purchase history to relative times from this reference time (one month before the reference month, or one month after the reference month, and the like). Moreover, the relative time conversion unit 102 takes the time, in the purchase history, when the target customer was designated as the analysis target as the reference time (an analysis month, for instance), and converts the times in each purchase history to relative times from this reference time (one month before the analysis month, or one month after the analysis month, and the like). Note that an example of the processing of the relative time conversion unit 102 will be described hereinafter with reference to FIG. 18 and the like.

The purchase history aggregation unit 103 aggregates the data of the items included in the purchase history of the model customer and aggregates the data of the items included in the purchase history of the target customer. Note that an example of the processing of the purchase history aggregation unit 103 will be described hereinafter with reference to FIG. 18 and the like.

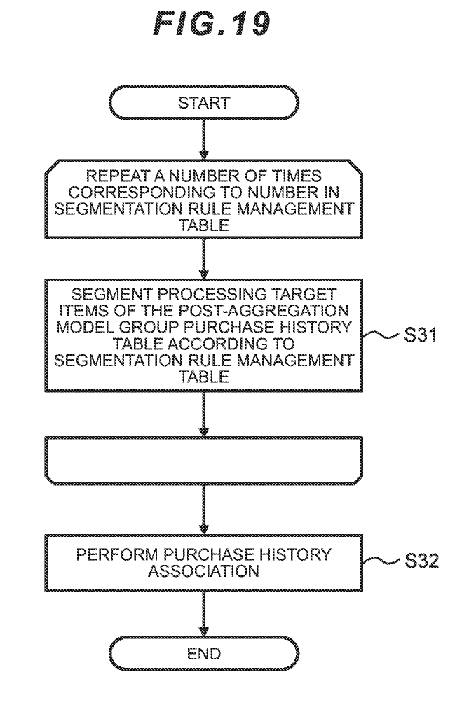

The purchase history segmentation unit 104 segments the data of the items included in the purchase history of the model customer and segments the data of the items included in the purchase history of the target customer. Note that an example of the processing of the purchase history segmentation unit 104 will be described hereinafter with reference to FIG. 19 and the like.

The behavior history creation unit 105 creates a behavior history for the model customer by associating each purchase history of the model customer. Moreover, the behavior history creation unit 105 creates a behavior history for the target customer by associating each purchase history of the target customer. Note that an example of the processing of the behavior history creation unit 105 will be described hereinafter with reference to FIG. 19 and the like.

The behavior history analysis unit 106 determines whether the behavior history of the target customer is included in the behavior history of the model customer based on each relative time of the behavior history with which each purchase history of the model customer has been associated and each relative time of the behavior history with which each purchase history of the target customer has been associated. Thereupon, for example, the behavior history analysis unit 106 may determine whether the behavior history of the target customer is included in the behavior history of the model customer based on the data of the model customer which has been aggregated by the purchase history aggregation unit 103 and the data of the target customer which has been aggregated by the purchase history aggregation unit 103. Thereupon, for example, the behavior history analysis unit 106 may determine whether the behavior history of the target customer is included in the behavior history of the model customer based on the data of the model customer which has been segmented by the purchase history segmentation unit 104 and the data of the target customer which has been segmented by the purchase history segmentation unit 104.

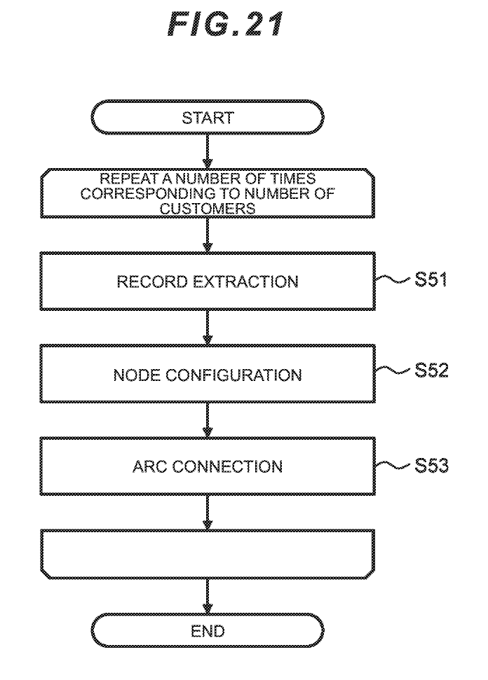

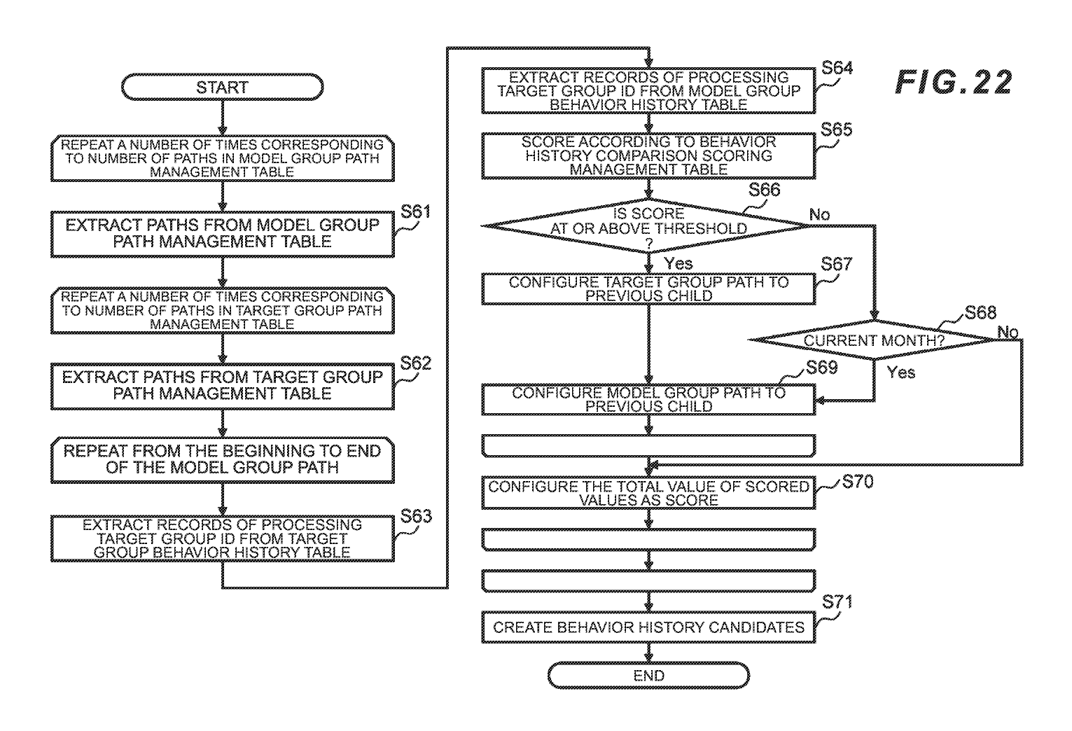

Moreover, the behavior history analysis unit 106 identifiably outputs a part, of the behavior history of the model customer, in which the behavior history of the target customer is included and a part in which the behavior history of the target customer is not included. For example, when there exist a plurality of the model customer, the behavior history analysis unit 106 may add a nonmatching behavior as a node for each behavior in the behavior history of the plurality of model customers, connect an arc to the added node to indicate each behavior history of the plurality of models, and display a screen which shows that each node has been associated by an arc, on a screen display unit. In this case, the behavior history analysis unit 106 may highlight the nodes among the added nodes for which there is a match between a behavior in the behavior history of the plurality of model customers and a behavior in the behavior history of the target customer. Note that an example of the processing of the behavior history analysis unit 106 will be described hereinafter with reference to FIGS. 21 and 22 and the like.

The client terminal 20 is, for instance, a computer such as a personal computer or a tablet terminal and is configured by comprising a central processing unit 21, a main memory device 22, and an auxiliary memory device and communication device which are omitted from the drawings. An input device 23 and an output device 24 are connected to the client terminal 20.

The central processing unit 21 is, for instance, a CPU and performs various arithmetic operations. The main memory device 22 is, for instance, a RAM and stores various information. Note that the auxiliary memory device is a ROM or HDD, and the like, and stores various information. The communication device is configured from an NIC, for example, and performs protocol control during communication with the data management apparatus 10.

The functions of the client terminal 20 (the screen display unit 201 and the like) may be realized by the central processing unit 21 reading a program which is stored in auxiliary memory device to the main memory device 22 and executing the program (software), may be realized by hardware such as a dedicated circuit, or may be realized by a combination of hardware and software. Moreover, a portion of the functions of the client terminal 20 could also be realized by another computer that is capable of communicating with the client terminal 20.

The input device 23 is a pointing device or keyboard or the like and is a device which performs various inputs according to operations from the user.

The output device 24 is, for instance, a display and displays various information. Note that the output device 24 may be a printing device which performs printing of various information to a medium such as paper.

Although a configuration in which the input device 23 and output device 24 are connected to the client terminal 20 has been explained in this embodiment as an example, the present invention is not limited to such a configuration. For example, the client terminal 20 may be configured by comprising the input device 23 and the output device 24, or the data management apparatus 10 may be configured by comprising the input device 23 and the output device 24, and other configurations are possible. Moreover, the input device 23 and output device 24 could also be realized by a single device (a touch panel, for example).

(Data Configuration)

FIG. 2 is a diagram showing an example of the customer master history table 111. The customer master history table 111 is a table for managing a customer state (for example, a profile linked to a points card) chronologically.

More specifically, the customer master history table 111 stores information that associates customers, a habits and tastes segment, a customer segment, and the age, sex, place of residence, number of family members, last year and month, and start year and month.

The customer field stores information indicating the customer (their full name, customer number and the like). The habits and tastes segment field stores information categorizing the customer as ‘bargain hunter’, ‘health-conscious’ and the like. Note that this habits and tastes segment may also be created by using the technology disclosed in International Patent No. 2016/016934, for example.

The customer segment field stores information categorizing the customer under the rank ‘optimal,’ ‘suboptimal,’ ‘general,’ or ‘estranged’. Note that the customer segment may also be created by using RFM analysis, for example. The age field stores information indicating the age of the customer. The sex field stores information indicating the sex of the customer. The place of residence field stores information indicating the place of residence of the customer. The number of family members field stores information indicating the number of members in the customer's family. The last year and month field and start year and month field store information on the last year and month and start year and month of a customer state (valid period of record) for customers to be managed chronologically.

Because a record is added when the information of any item is updated in the customer master history table 111, customer states can be managed chronologically.

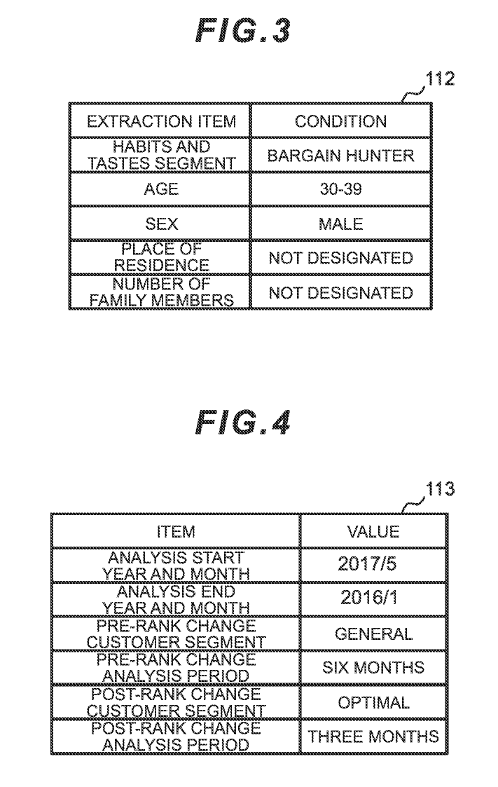

FIG. 3 is a diagram showing an example of the group extraction management table 112. The group extraction management table 112 is a table for managing the extraction conditions for extracting an analysis-target group (analysis-target customers are extracted from all the customers as a group).

The group extraction management table 112 stores information which associates extraction items and conditions. Customers for whom the values of extraction items and conditions match are extracted from the customer master history table 111 as a group. Note that optional values can be stored for the extraction items and conditions.

FIG. 4 is a diagram showing an example of the model group reference period table 113. The model group reference period table 113 is a table for prescribing reference periods of a group serving as the model within the analysis-target group.

The model group reference period table 113 stores information that associates an analysis start year and month, an analysis end year and month, a pre-rank change customer segment, a pre-rank change analysis period, a post-rank change customer segment, and a post-rank change analysis period.

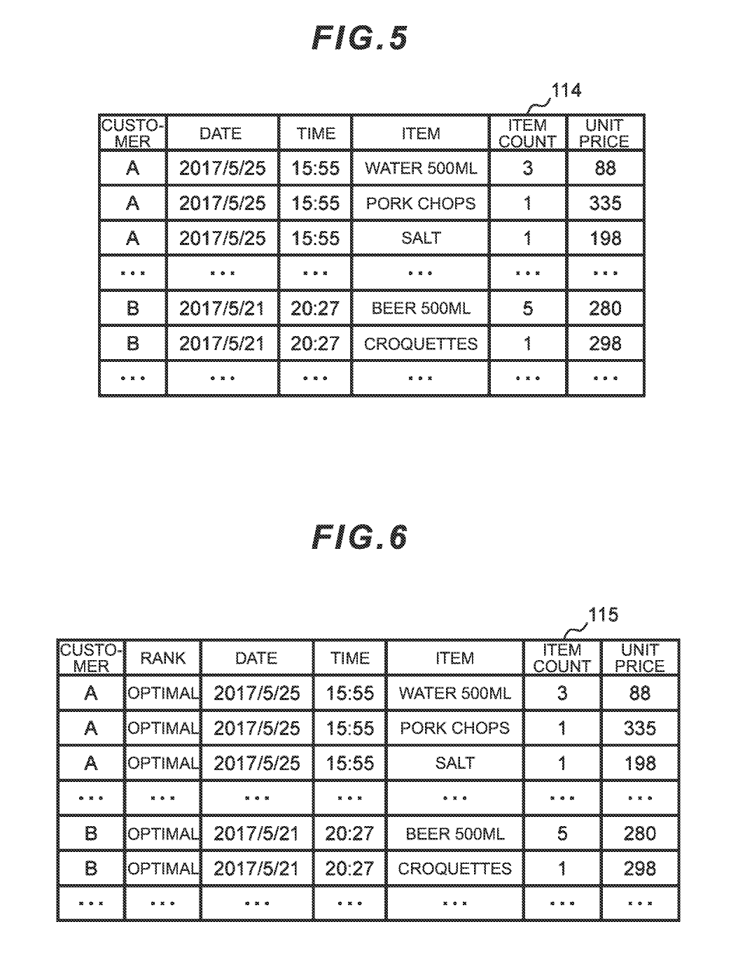

A group of optimal customers (model group) is extracted from the analysis target group by using the model group reference period table 113. More specifically, customers whose rank, which is specified by the pre-rank change customer segment and post-rank change customer segment, has changed from ‘non-optimal’ to ‘optimal’ in the reference period configured by the analysis start year and month and analysis end year and month are extracted from the analysis target group as a model group. Note that the records of the pre-rank change analysis period (purchase history) and the records of the post-rank change analysis period (purchase history) are extracted from the purchase history table 114 shown in FIG. 5 based on the pre-rank change analysis period and post-rank change analysis period.

FIG. 5 is a diagram showing an example of the purchase history table 114. The purchase history table 114 manages the purchase history information of all the customers (for example, data recording product sales information whenever a customer is sold a product in a store). Information which is gathered by a POS system, for example, may be used as the purchase history information.

The purchase history table 114 stores information which associates the customer, date, time, item, count, and price. The date field stores date information indicating the date the customer purchased a product. The time field stores time information indicating the time the customer purchased the product. The item field stores item information indicating the product item the customer purchased. The count field stores count information indicating the number of products the customer purchased. The price field stores price information indicating the price of the product the customer purchased.

FIG. 6 is a diagram showing an example of the model group purchase history table 115. The model group purchase history table 115 is a table which stores model group purchase history which is extracted from the purchase history table 114 based on the group extraction management table 112 and the model group reference period table 113. Note that the processing for extracting this model group purchase history will now be explained with reference to FIG. 17.

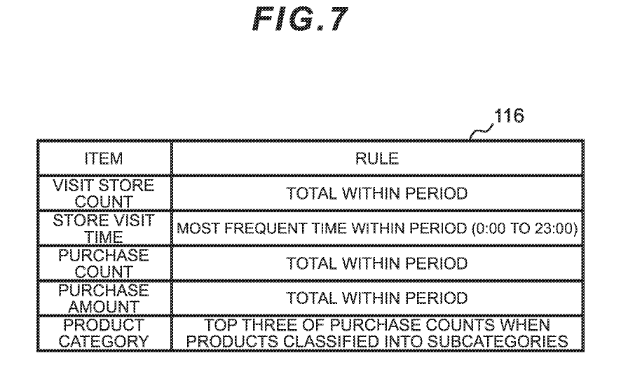

FIG. 7 is a diagram showing an example of the aggregation rule management table 116. The aggregation rule management table 116 is a table which stores rules for aggregating the purchase history of a model group at a detailed level.

The aggregation rule management table 116 stores information which associates extraction items and rules. The item field stores information for the column names of the purchase history table 114. The rule field stores information for the aggregation rules. Note that optional values can be stored for the items and rules. In the example shown in FIG. 7, rules, such as a rule to add up the store visit counts within a period (one month, for example), are stored.

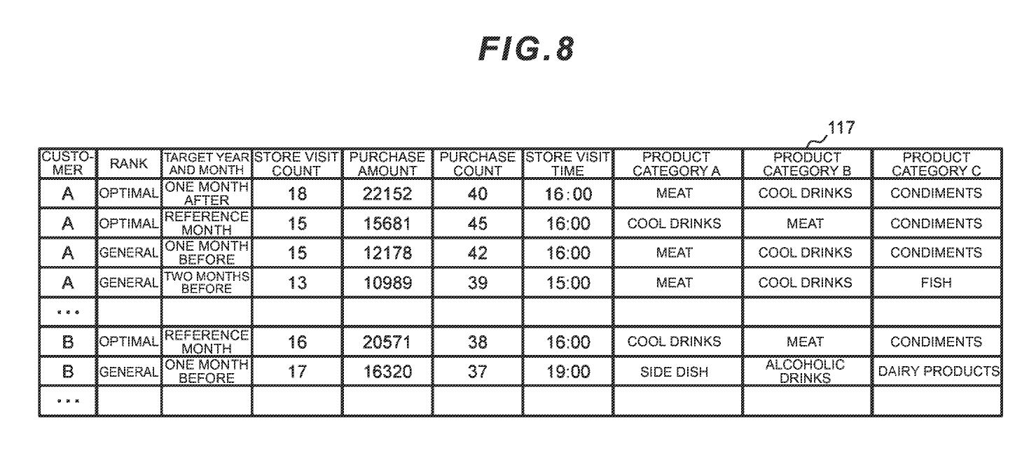

FIG. 8 is a diagram showing an example of the post-aggregation model group purchase history table 117. The post-aggregation model group purchase history table 117 is a table obtained by aggregating the model group purchase history table 115 according to the aggregation rule management table 116. Note that the processing for aggregating the purchase history of the model group purchase history table 115 will now be explained with reference to FIG. 18.

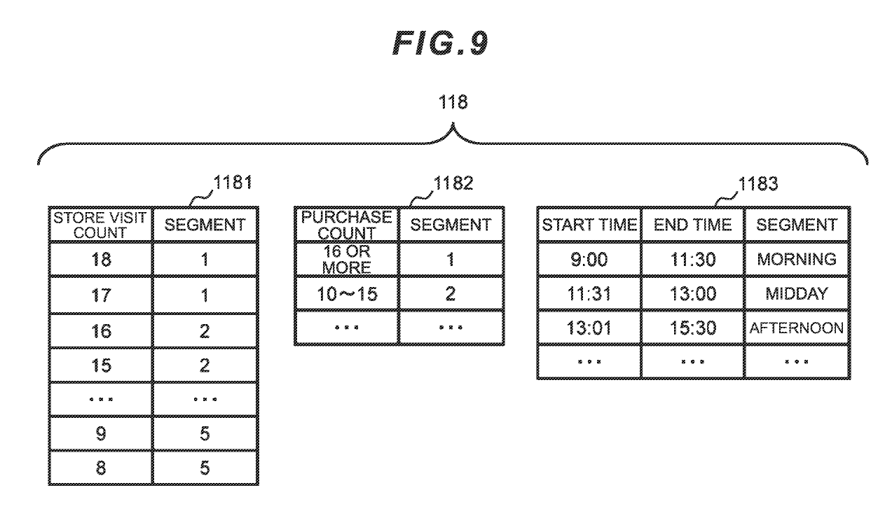

FIG. 9 is a diagram showing an example of the segmentation rule management table group 118. The segmentation rule management table group 118 is a table group which manages rules for segmenting each item of the post-aggregation model group purchase history table 117 (note that the model group purchase history table 115 may also be used). A number of tables corresponding to the number of items to be segmented are prestored.

FIG. 9 illustrates a store visit count table 1181 for managing segmentation rules for store visit counts, a purchase count table 1182 for managing segmentation rules for purchase counts, and a store visit time table 1183 for managing segmentation rules for store visit times. Optional counts and optional segmentation rules can be configured (held) in the segmentation rule management table group 118.

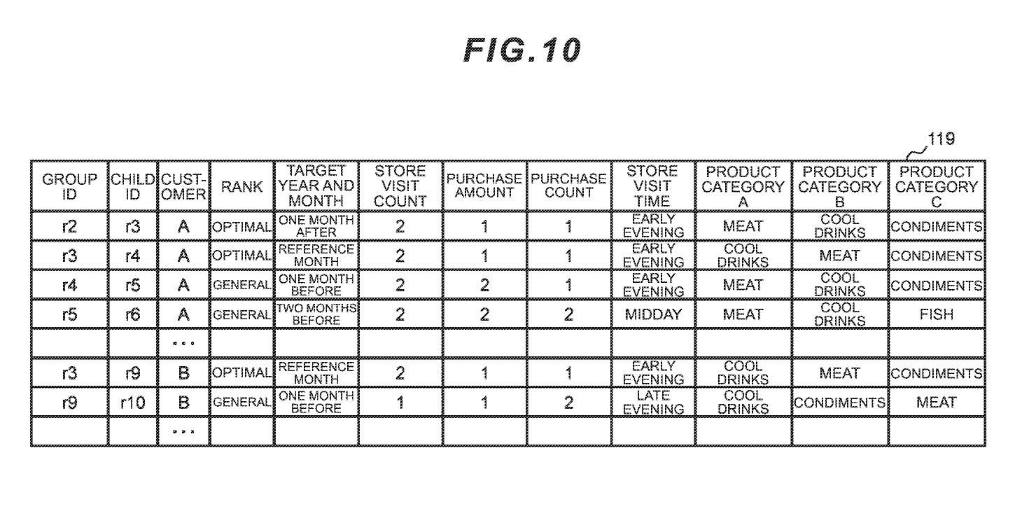

FIG. 10 is a diagram showing an example of the model group behavior history table 119. The model group behavior history table 119 is a table which manages the behavior histories of the model groups obtained as a result of aggregating and segmenting the model group purchase history table 115 (information which is obtained by aggregating and segmenting the items of each purchase history of the model groups and in which the respective purchase histories are associated). Note that the processing for segmenting the purchase history of the post-aggregation model group purchase history table 117 and processing for associating the respective purchase histories will now be explained with reference to FIG. 19.

In the model group behavior history table 119 shown in FIG. 10, the purchase histories of the model groups are aggregated in month units, and the store visit counts, purchase amounts, purchase counts and store visit times are segmented. Note that the product category holds the top three purchase counts, obtained by classifying the products in subcategories.

The model group behavior history table 119 is a table for chronologically storing customer behavior histories by means of the ‘customer’ item and ‘target year and month’ item, and what is designated as the behavior history can be optionally held by means of the aggregation rule management table 116 and segmentation rule management table group 118, for example. In the model group behavior history table 119 shown in FIG. 10, an example in which the store visit counts, purchase amounts, purchase counts and store visit time and product categories are held as the behavior history.

The model group behavior history table 119 stores information which associates the group ID, child ID, customer, rank, target year and month, store visit count, purchase amount, purchase count, store visit time, product category A, product category B, and product category C.

The group ID stores an identifier for identifying a group when each item excluding the ‘customer’ item is taken as an aggregation unit (group) The child ID stores the target year and month group ID when the target year and month is one month before.

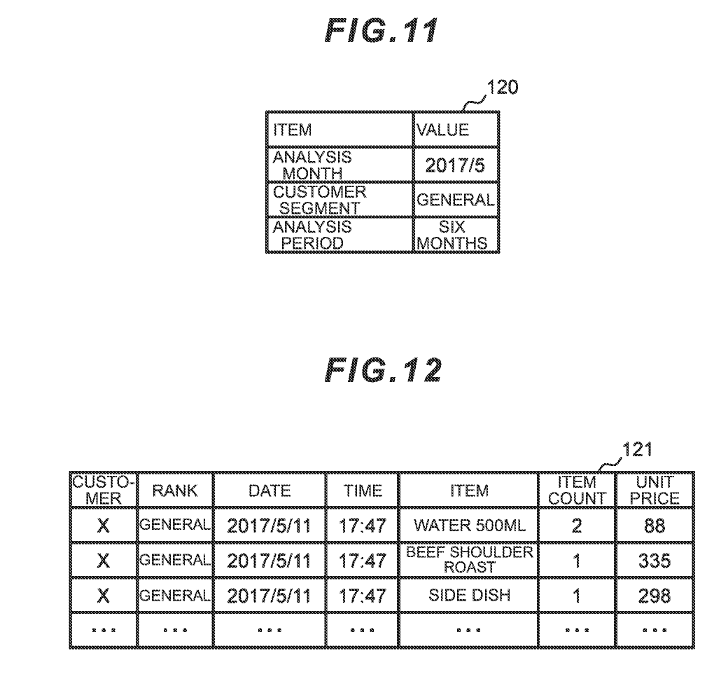

FIG. 11 is a diagram showing an example of the target group reference period table 120. The target group reference period table 120 is a table for prescribing a reference period of a group serving as the target within the analysis-target group.

The target group reference period table 120 stores information which associates the analysis month, customer segment, and the analysis period. The analysis month stores information indicating the analysis target month (the current year and month, for example; will be suitably explained hereinafter by citing the current year and month by way of an example). The analysis period stores information indicating the analysis period. For example, when the analysis month is ‘2017 May’ and the analysis period is ‘six months,’ the purchase history over the six-month period ‘2016 December to 2017 May’ will be analyzed. Note that customers satisfying the customer segment condition are extracted from the analysis target group as the target group.

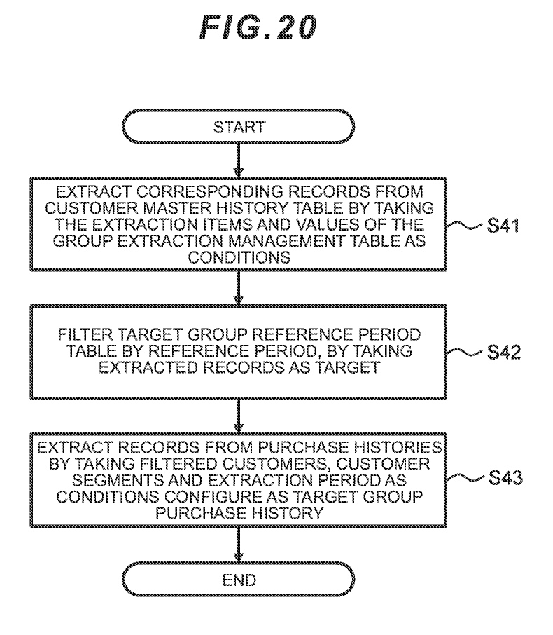

FIG. 12 is a diagram showing an example of the target group purchase history table 121. The target group purchase history table 121 is a table which stores the target group purchase history which is extracted from the purchase history table 114 based on the group extraction management table 112 and the target group reference period table 120. Note that the processing for extracting this target group purchase history will now be explained with reference to FIG. 20.

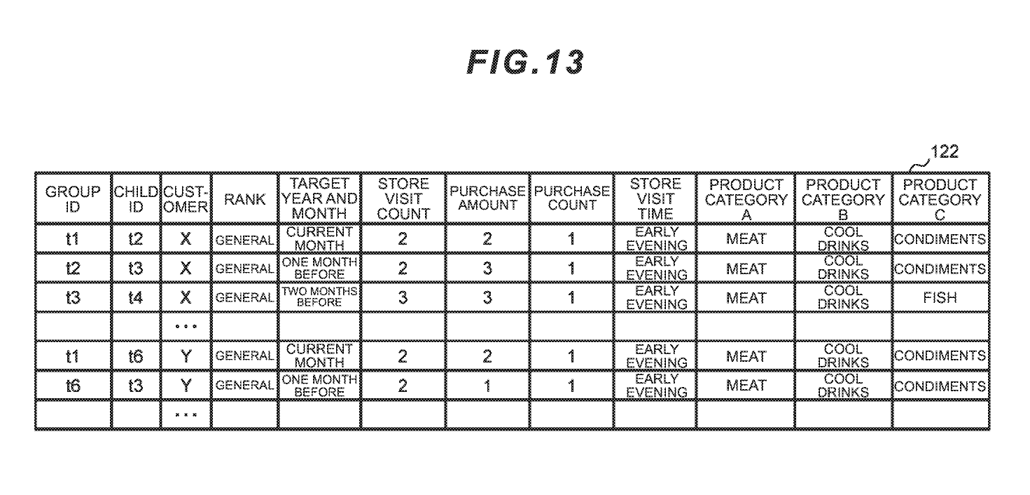

FIG. 13 is a diagram showing an example of the target group behavior history table 122 (information which is obtained by aggregating and segmenting the items of each purchase history of the target groups and in which the respective purchase histories are associated). The target group behavior history table 122 is a group for managing the behavior histories of the target group and which is obtained by aggregating and segmenting the target group purchase history table 121. Note that the processing for aggregating and segmenting the target group purchase history table 121 and processing for associating the respective purchase histories are the same as the processing of FIGS. 18 and 19, and therefore an explanation of the former is omitted.

In the target group behavior history table 122 shown in FIG. 13, the purchase histories of the target groups are aggregated in month units, and the store visit counts, purchase amounts, purchase counts and store visit times are segmented. Note that the product category holds the top three purchase counts, obtained by classifying the products in subcategories.

The target group behavior history table 122 is a table for chronologically storing customer behavior histories by means of the ‘customer’ item and ‘target year and month’ item, and what is designated as the behavior history can be optionally held by means of the aggregation rule management table 116 and segmentation rule management table group 118, for example. In the target group behavior history table 122 shown in FIG. 13, an example in which the store visit counts, purchase amounts, purchase counts and store visit time and product categories are held as the behavior history.

The target group behavior history table 122 stores information which associates the group ID, child ID, customer, rank, target year and month, store visit count, purchase amount, purchase count, store visit time, product category A, product category B, and product category C.

The group ID stores an identifier for identifying a group when each item excluding the ‘customer’ item is taken as an aggregation unit (group) The child ID stores the target year and month group ID when the target year and month is one month before.

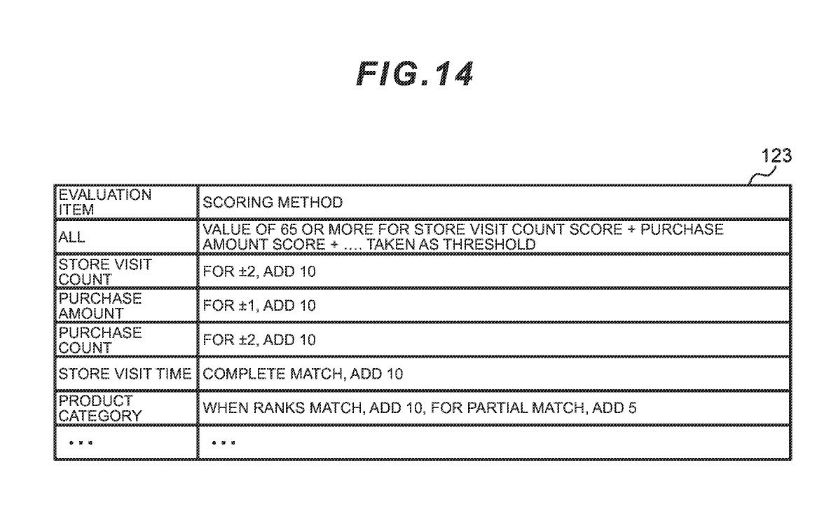

FIG. 14 is a diagram showing an example of the behavior history comparison scoring management table 123. The behavior history comparison scoring management table 123 is a table for managing scoring methods for comparing a model group behavior history with a target group behavior history.

The behavior history comparison scoring management table 123 stores information which associates evaluation items and scoring conditions. For each of the items stored in the evaluation items, scoring is calculated by applying scoring algorithms which are stored in the scoring methods, and the behavior histories are compared based on the calculated score.

The evaluation items and scoring methods shown in FIG. 14 are merely examples and optional evaluation items and scoring algorithms can be stored.

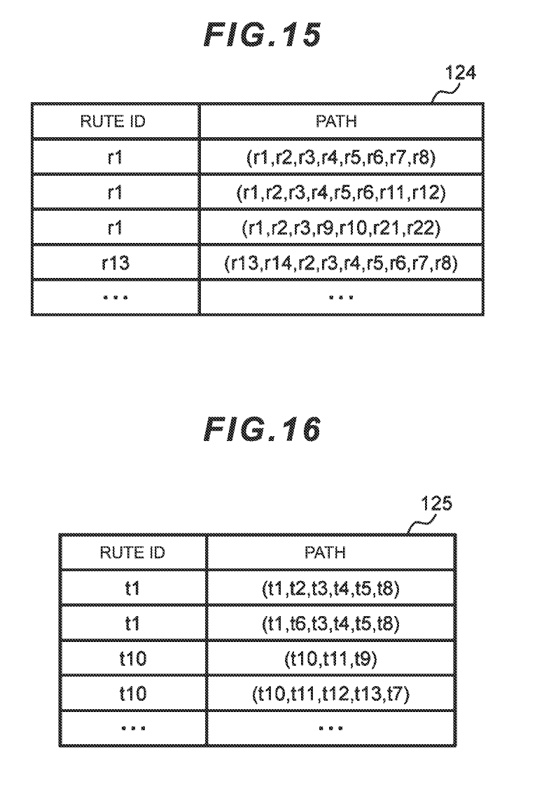

FIG. 15 is a diagram showing an example of the model group path management table 124. The model group path management table 124 is a table which manages data, obtained by resolving the group ID and child ID of the model group behavior history, as the path of the model group.

The model group path management table 124 stores information which associates rule IDs and paths. Note that path configuration will now be explained with reference to FIG. 21.

FIG. 16 is a diagram showing an example of the target group path management table 125. The target group path management table 125 is a table which manages data, obtained by resolving the group ID and child ID of the target group behavior history, as the path of the target group.

The target group path management table 125 stores information which associates rule IDs and paths. Note that path configuration will now be explained with reference to FIG. 21.

(Analysis-Related Processing)

FIG. 17 is a diagram showing an example of process steps relating to processing for extracting a model group purchase history.

The purchase history extraction unit 101 extracts corresponding records (analysis-target group) from the customer master history table 111 based on the extraction items and conditions of the group extraction management table 112 (step S11). For example, in the case of the example shown in FIG. 3, the purchase history extraction unit 101 extracts the records of customers for whom the habits and tastes segment is ‘bargain hunter,’ the age is ‘30-39,’ and the sex is ‘male,’ from the customer master history table 111. Note that, in this processing, filtering by customer segment is not performed.

Taking the extracted records as the target, the purchase history extraction unit 101 performs configuration to filter the records by the reference period of the model group reference period table 113 (the analysis start year and month and analysis end year and month) (step S12). For example, in the case of the example shown in FIG. 4, the purchase history extraction unit 101 configures the data over the sixteen-month period from 2016 January to 2017 May as the reference period, taking the extracted records as the target.

Moreover, the purchase history extraction unit 101 extracts the records of the customers for whom the customer segment rank has changed from ‘general’ to ‘optimal’ in the reference period. Moreover, by taking the month when the rank changed as a reference, the purchase history extraction unit 101 configures the previous six months of the ‘general’ purchase history extraction period and the previous three months of the ‘optimal’ purchase history extraction period as purchase history extraction period conditions.

The purchase history extraction unit 101 extracts records from the purchase history table 114 by taking the filtered customers, customer segments and extraction periods as conditions, and stores these records in the model group purchase history table 115 as the purchase history of the model group (step S13).

FIG. 18 is a diagram showing an example of process steps relating to processing for aggregating purchase histories of the model group purchase history table 115.

The relative time conversion unit 102 converts the dates in the model group purchase history table 115 to relative values by taking the year and month the rank changed as a reference (step S21). Thereupon, the relative time conversion unit 102 converts (configures) the year and month the rank changed as the reference month. For example, by taking the reference months as a reference, the relative time conversion unit 102 converts a previous year and month as ‘one month before’ and ‘two months before’ and a future year and month as ‘one month after’ and ‘two months after,’ and the like.

The purchase history aggregation unit 103 aggregates the purchase histories of the model group purchase history table 115 based on the aggregation rule management table 116 (step S22). More specifically, the purchase history aggregation unit 103 aggregates (computes) the items in the model group purchase history table 115 which match items in the aggregation rule management table 116, according to the rules of the aggregation rule management table 116, and stores the aggregated result in the post-aggregation model group purchase history table 117.

FIG. 19 is a diagram showing an example of process steps relating to processing for segmenting purchase histories of the post-aggregation model group purchase history table 117.

The purchase history segmentation unit 104 segments the processing target items of the post-aggregation model group purchase history table 117 according to the segmentation rule management table group 118 (step S31). For example, for the store visit counts table 1181 shown in FIG. 9, a rule for segmenting a store visit count of ‘18’ or ‘17’ as segment ‘1’ and a store visit count of ‘16’ or ‘15’ as segment ‘2’ is configured. According to the store visit count rule, because the store visit count of the first record in post-aggregation model group purchase history table 117 shown in FIG. 8 is ‘18’, segmentation with the value ‘1’ is performed.

When segmentation is performed, the behavior history creation unit 105 performs purchase history associations (step S32). More specifically, the behavior history creation unit 105 configures group IDs in the model group behavior history table 119 by taking each item excluding ‘customer’ as aggregation units (groups). Moreover, the behavior history creation unit 105 configures a target year and month group IDs for which the target year and month is one month before in the model group behavior history table 119. Note that the child IDs can be listed because there may be a plurality of child IDs.

FIG. 20 is a diagram showing an example of process steps relating to processing for extracting a target group purchase history.

The purchase history extraction unit 101 extracts corresponding records (analysis-target group) from the customer master history table 111 based on the extraction items and conditions of the group extraction management table 112 (step S41). For example, in the case of the example shown in FIG. 3, the purchase history extraction unit 101 extracts the records of customers for whom the habits and tastes segment is ‘bargain hunter,’ the age is ‘30-39,’ and the sex is ‘male,’ from the customer master history table 111. Note that steps S11 and S41 have the same processing content.

Taking the extracted records as the target, the purchase history extraction unit 101 performs configuration to filter the records by the reference period of the target group reference period table 120 (the analysis month and month and analysis period) (step S42). For example, in the case of the example shown in FIG. 11, the purchase history extraction unit 101 configures the data over the six-month period from 2016 December to 2017 May as the reference period, taking the extracted records as the target.

The purchase history extraction unit 101 extracts records from the purchase history table 114 by taking the filtered customers, customer segments and extraction periods as conditions, and stores these records in the target group purchase history table 121 as the purchase history of the target group (step S43).

Thereafter, the processing for aggregating and segmenting the extracted records is performed and behavior histories of the target group are created. However, an explanation of this processing is omitted because this processing is the same as for the model group (FIGS. 18 and 19).

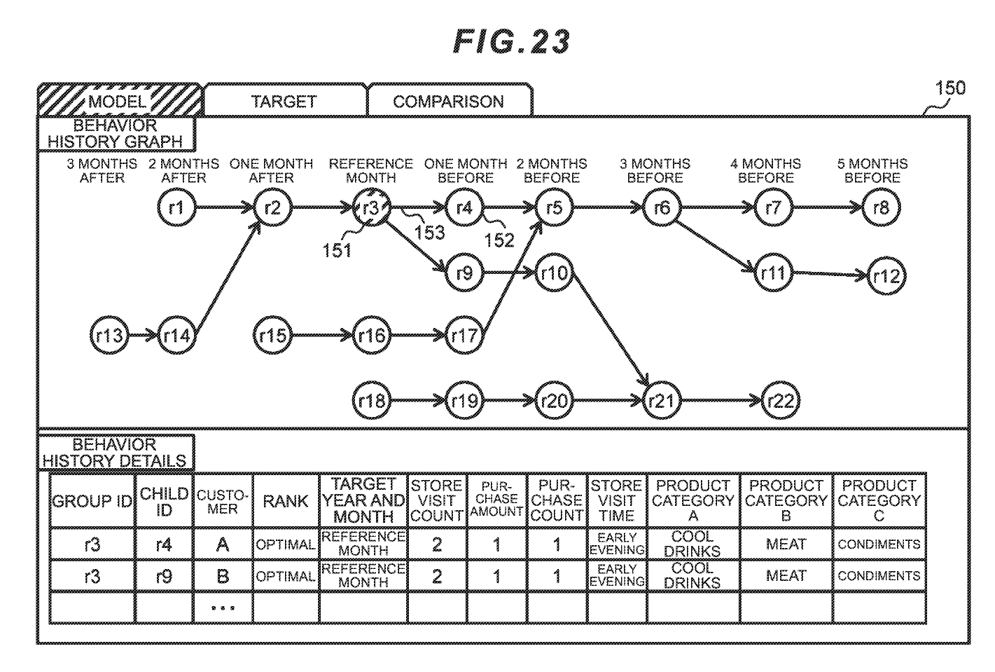

FIG. 21 is a diagram showing an example of process steps relating to processing for visualizing a behavior history. According to this processing, the screen displays shown in FIGS. 23 to 25 can be executed, for example.

The behavior history analysis unit 106 performs record extraction (step S51). Here, the behavior history analysis unit 106 refers to the model group behavior history table 119 and acquires all the records of the processing target customers. For example, the behavior history analysis unit 106 extracts all the records of customer ‘A’ from the model group behavior history table 119 shown in FIG. 10.

The behavior history analysis unit 106 then configures nodes (step S52). More specifically, the behavior history analysis unit 106 adds one record indicating one behavior in the behavior history of the model group as one node. Thereupon, when a matching node already exists, the behavior history analysis unit 106 does not add a node. The behavior history analysis unit 106 determines whether nodes match depending on whether the values of a predetermined item in the behavior history match (in the example in FIG. 10, the target year and month, store visit count, purchase amount, store visit time, product category A, product category B, and product category C). For example, in FIG. 10, because the values of the predetermined item in the behavior history match for the record in which the target year and month of customer ‘A’ is the ‘reference month’ and the target year and month of customer ‘B’ is the ‘reference month,’ the behavior history analysis unit 106 determines that the nodes match.

The behavior history analysis unit 106 then connects the arcs (step S53). For example, the behavior history analysis unit 106 searches chronologically (starting with newer records, for example) for records for which the group ID of the processing target record has been configured to the child ID, and when this record is present, connects an arc from the node of this record to the node of the processing target record. The behavior history analysis unit 106 configures, upon connecting arcs for the processing target customers, the group IDs of the roots (latest records) as the ‘root IDs’ and configures the paths from the ‘root IDs’ in ‘path’ as lists, and stores these paths in the model group path management table 124.

The behavior history analysis unit 106 repeats the processing of steps S51 to S53 the same number of times as the number of customers in the model group behavior history table 119. Moreover, the behavior history analysis unit 106 similarly repeats the processing of steps S51 to S53 the same number of times as the number of customers in the target group behavior history table 122. According to this processing, the behavior histories can be visualized (a behavior history graph can be displayed, for example).

FIG. 22 is a diagram showing an example of process steps relating to processing for comparing a model group behavior history with a target group behavior history. In this processing, each of the behavior histories are chronological data which is managed using relative months, and hence a comparison is made while shifting the target year and month of the behavior histories of the target group, by taking the behavior histories of the model group as a reference.

First, the behavior history analysis unit 106 extracts the path record from the model group path management table 124 and configures same as the comparison target path (step S61).

Thereafter, the behavior history analysis unit 106 extracts the path record from the target group path management table 125 (step S62).

The behavior history analysis unit 106 then extracts the records of the processing target group IDs from the target group behavior history table 122 (step S63).

The behavior history analysis unit 106 then extracts the records of the processing target group IDs from the model group behavior history table 119 (step S64).

The behavior history analysis unit 106 then performs scoring using the scoring methods which are stored in the behavior history comparison scoring management table 123 (step S65). For example, the behavior history analysis unit 106 compares the store visit count of a model group behavior history with the store visit count of a target group behavior history and, when the difference in the values between the former and latter is ‘2’ or less, adds ‘10’ to the score. The behavior history analysis unit 106 thus calculates the score for all the evaluation items.

The behavior history analysis unit 106 then determines whether the total calculated score is at or above a threshold value (′65,′ for example) (step S66). Upon determining that this score is at or above the threshold value, the behavior history analysis unit 106 shifts the processing to step S67 and, upon determining that this score is less than the threshold value, shifts the processing to step S68. Note that the threshold value could also be stored in the behavior history comparison scoring management table 123, stored in another table in the data management apparatus 10, or stored in a table that is not shown.

Moreover, in step S67, the behavior history analysis unit 106 configures the target group path to the previous child and shifts the processing to step S69. Thereupon, the behavior history analysis unit 106 records processing target path information (the group ID, for example) for the model group in order to make it possible to identify the parts, of the behavior history of the model group, which include the behavior history of the target customer and the parts which do not include the behavior history of the target customer, respectively.

In step S68, the behavior history analysis unit 106 determines whether the processing target year and month of the target group is the ‘current month’. Upon determining that processing target year and month of the target group is the ‘current month,’ the behavior history analysis unit 106 shifts the processing to step S69 and, upon determining that this processing target year and month is not the ‘current month,’ shifts the processing to step S70.

In step S69, the behavior history analysis unit 106 configures the path of the model group to the previous child.

In step S70, the behavior history analysis unit 106 configures the total value of the scored values as the score (display score). A path of a target group with a high score is similar to a model group.

Here, when the score calculated in step S65 is at or above the threshold value, the behavior history analysis unit 106 determines that the behavior history of a model group for which the processing target is the year and month is similar to the behavior history of the target group. Furthermore, when the behavior histories are similar, the behavior history analysis unit 106 configures the processing target year and month of the target group to a child one month before and configures the processing target year and month of the model group to a child one month before. Meanwhile, if the threshold value is not satisfied, when the processing target year and month of the target group is ‘current month,’ the behavior history analysis unit 106 configures only the processing target year and month of the model group to a child one month before and continues the comparison with the current month of the target group. While shifting the processing target year and month of the model group and target group in this manner, processing is performed to compare the behavior histories from the beginning to the end of the model group path and is repeated to the end of the target group path. Note that when the processing target year and month is not the ‘current month,’ the processing target is shifted to the next target group.

By repeating the foregoing processing for all the target group behavior histories, it is possible to extract the data of the parts similar to the target group behavior history from the model group behavior history (in the case of a graph, extraction of a partial graph is possible).

In step S71, the behavior history analysis unit 106 creates behavior history candidates. For example, for each model group, the behavior history analysis unit 106 specifies the target group with the highest display score among the display scores calculated for each target group. The target groups specified for each of the model groups are taken as the processing target from target groups with a new current month, and the nodes with group IDs recorded in these processing-target target groups are configured as highlighting targets. Thereupon, when current month nodes of the processing-target target group have already been configured as highlighting targets in nodes which are not current month nodes of another target group, the behavior history analysis unit 106 shifts the processing target to the next target group without designating the processing-target target group as a highlighting target.

According to this processing, by taking the newest node of a matching part as a reference, it is then possible to display the possibility of a behavior being adopted by a customer of the target group in this node.

FIG. 23 is a diagram showing an example of visualization of a model group behavior history (a model group behavior history screen 150).

In the upper portion of the model group behavior history screen 150, the behavior history is displayed as an ‘action history graph’ which is a directed graph in which the latest year and month in the analysis period is on the left, the oldest year and month is on the right, and in which the behaviors of each year and month in the customer behavior history are nodes which are each connected by arcs.′ Note that through aggregation and segmentation, the same record is bundled together as one node.

For example, by clicking on node 151, the content (records) of the behaviors in the behavior history of the corresponding model group is displayed in the ‘action history details’ in the lower portion of the screen. For example, it can be seen that the first record is the behavior history of customer ‘A’ but that a child node 152 is ‘r4,’ which can be easily grasped in the behavior history graph from the arc 153 which connects node 151 and node 152.

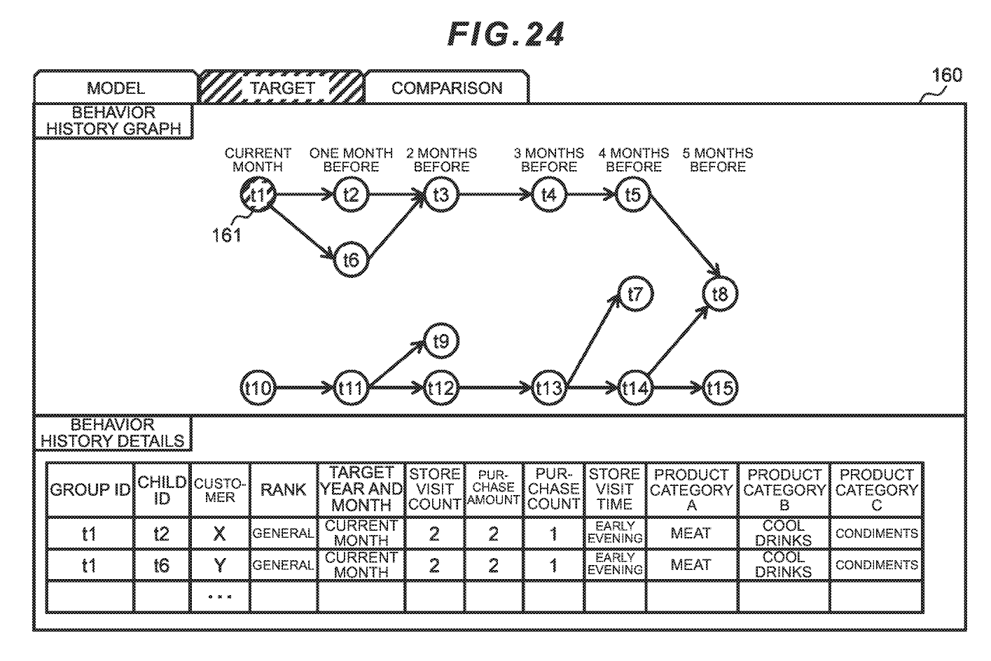

FIG. 24 is a diagram showing an example of visualization of a target group behavior history (a target group behavior history screen 160). The model group behavior history screen 150 and target group behavior history screen 160 basically only have different data, and the configuration and function of the target group behavior history screen 160 are the same as the model group behavior history screen 150.

Note that FIG. 24 is an example of a screen when the node 161 is clicked, and the content (records) of behaviors in the behavior history of the corresponding target group are displayed in ‘action history details’ in the lower portion of the target group behavior history screen 160.

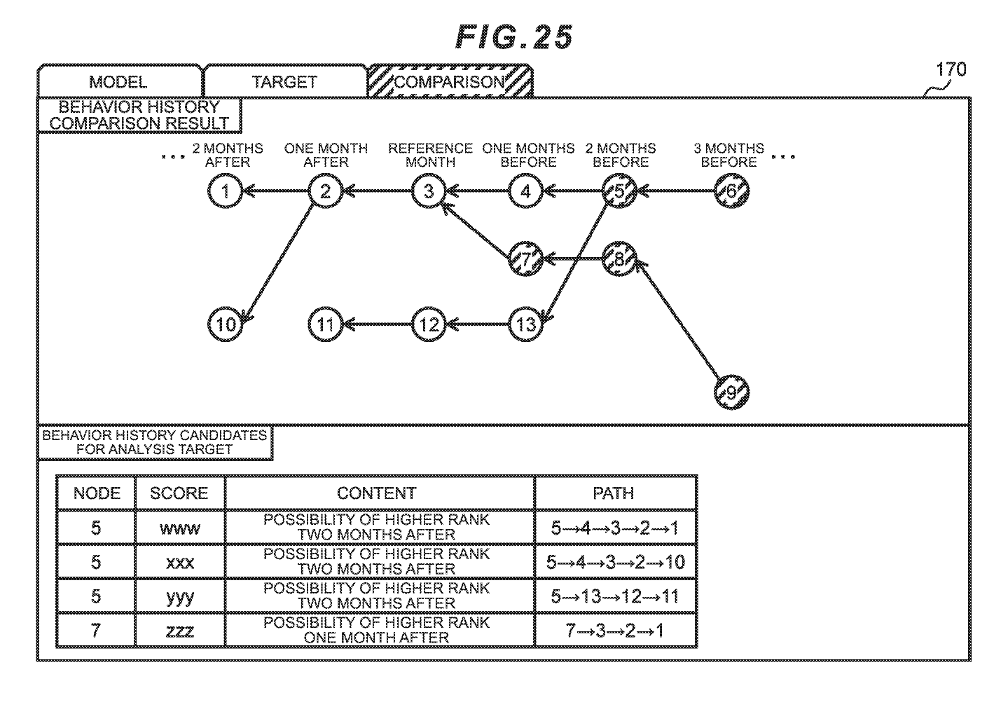

FIG. 25 is a diagram showing an example of visualization of a comparison result comparing a model group behavior history with a target group behavior history (a behavior history comparison result screen 170).

In the behavior history comparison result screen 170, the data that is determined as being similar in the model group behavior history and target group behavior history is displayed in a graph as an ‘action history comparison result’ in the upper portion of the screen. The data for which similar highlighted nodes (node ‘5’ to node ‘9’) have been determined and the unhighlighted nodes (node ‘1’ to node ‘4’ and node ‘10’ to node ‘13’) is data of behaviors which may possibly be adopted by the target group in the future. In other words, the behavior history of the model group includes data for which an increase in rank from ‘general’ to ‘optimal’ has already been achieved. The target group behavior history is only ‘general’ data. Accordingly, for target groups with a similar part, the data of the year and month preceding the current month, among the model group data, can be regarded as data of behaviors which may possibly be adopted by the target group in the future.

‘Analysis target behavior history candidates’ in the lower portion of the screen presents possibilities that target groups, determined as being similar, will achieve a higher rank in the future. For example, the first record shows that node ‘5’ in the upper portion of the screen is similar to the current month in the behavior history of the target group. The scoring results are presented in the score (display score) section. Note that the larger the number of subsequent matching nodes, the higher the score. The content section presents the possibility that a higher rank will be achieved two months thereafter in comparison with the reference month (the year and month when the model group achieved a higher rank). Moreover, the node number presents the paths.

According to the behavior history comparison result screen 170, because the model group can be specified for a target group, it is possible to analyze the main reason why the model group achieved a higher rank, such as the time, which measures had been taken, which new products had been brought to market, and what had been fashionable, and to devise effective measure planning for the target group.

According to this embodiment, it is possible to perform an analysis enabling the target group to achieve a higher rank by comparing a behavior history investigation against the measures background.

### (2) Other Embodiments

Note that, although a case where the present invention is applied to a data management system was described in the foregoing embodiment, the present invention is not limited thereto, and can be widely applied to a variety of other systems, data management apparatuses and data management methods.

Moreover, although, in the foregoing embodiment, a case where the present invention is applied to a model group (a plurality of model customers) and a target group (a plurality of target customers) was described, the present invention is not limited to a number of model customers or a number of target customers. For example, the present invention could also be applied to a case where there are any number of model customers and target customers, a case where there is a single model customer and a plurality of target customers, or a case where there are a plurality of model customers and a single target customer.

Furthermore, although, in the foregoing embodiment, a case where the year and month were taken as the units of a reference period when a higher rank was achieved and when an analysis target was designated, the present invention is not limited thereto, rather, other units of time may also be applied. For example, units such as a half-day unit, a day unit, a week unit, a 10-day unit, a 3-month unit, or a year unit, or other units, are possible.

Moreover, although, in the foregoing embodiment, a case where behavior histories are created by aggregating and segmenting purchase histories was described, the present invention is not limited thereto, rather, the behavior histories may be created by only aggregating the purchase histories, or the behavior histories may be created by only segmenting the purchase histories, or the behavior histories may be created by neither aggregating nor segmenting the purchase histories. Note that the order of aggregation and segmentation may also be such that aggregation is performed after segmentation.

Moreover, although, in the foregoing embodiment, a case where the model group behavior history screen 150 is displayed as an example of visualizing (outputting) the behavior history of a model group was described, the present invention is not limited thereto, rather, the model group behavior history may be printed or the model group behavior history may be output as a file, or the information of the model group behavior history may be sent to a predetermined electronic mail address, or another output technique may be adopted.

Moreover, although, in the foregoing embodiment, a case where the target group behavior history screen 160 is displayed as an example of visualizing (outputting) the behavior history of a target group was described, the present invention is not limited thereto, rather, the target group behavior history may be printed or the target group behavior history may be output as a file, or the information of the target group behavior history may be sent to a predetermined electronic mail address, or another output technique may be adopted.

Moreover, although, in the foregoing embodiment, a case where the behavior history comparison result screen 170 is displayed as an example of visualizing (outputting) a comparison result comparing a model group behavior history and a target group behavior history was described, the present invention is not limited thereto, rather, the behavior history comparison result may be printed or the behavior history comparison result may be output as a file, or the information of the behavior history comparison result may be sent to a predetermined electronic mail address, or another output technique may be adopted.

Moreover, although, in the foregoing embodiment, a case was described where, in the processing which compares the model group behavior history with the target behavior history, the behaviors (nodes) are compared in a round-robin process, the present invention is not limited thereto, rather, each behavior in the target group behavior history may be compared with behaviors up until the reference month among the behaviors of the model group behavior history. In such a case, the number of comparison processing steps can be reduced, and the computational load can be reduced.

Moreover, although, in the foregoing embodiment, a case was described where the behavior history comparison result screen 170 displays a graph showing possibilities of behaviors being adopted by target customers belonging to a node, the present invention is not limited thereto, rather, the behavior history comparison result screen 170 may display, for each target customer, a graph of possibilities of behaviors being adopted by the target customer. In such a case, a GUI (Graphical User Interface: a search mechanism, select mechanism, and the like) for designating the target customer to be displayed on the screen is suitably displayed. According to this configuration, the individual data of the target customer can be easily analyzed.

Moreover, although, in the foregoing embodiment, a case was described where the behavior history comparison result screen 170 displayed a series of highlighted behaviors for which there was a match between behaviors in the model group behavior history and behaviors in the target group behavior history, the present invention is not limited thereto, rather, it is also possible to highlight only the nodes for which there is a match between behaviors in the model group behavior history and behaviors when designated as analysis targets in the target group behavior history, among the behaviors of the model group behavior history. In this configuration, it is also possible to grasp which behaviors a target customer should adopt in the future to achieve a higher rank.

Furthermore, although various data have been explained in the foregoing embodiment by using variously named tables for the sake of explanation, the data structure is not limited, and the data may be represented by variously named information and the like.

Moreover, in the foregoing explanations, the information of the programs, tables, files and the like representing each of the functions can be placed on memory devices such as memory, hard disks and SSD, or on recording media such as IC cards, SD cards and DVDs.

Furthermore, the foregoing configurations may be suitably changed, switched, combined, or omitted within a range that does not depart from the spirit of the present invention.

### REFERENCE SIGNS LIST

1 . . . data management system, 10 . . . data management apparatus, 20 . . . client terminal, 101 . . . purchase history extraction unit, 102 . . . relative time conversion unit, 103 . . . purchase history aggregation unit, 104 . . . purchase history segmentation unit, 105 . . . behavior history creation unit, 106 . . . behavior history analysis unit, 201 . . . screen display unit.

What is claimed is:

1. A data management apparatus, comprising:
a relative time conversion unit which, for a purchase history of a model customer who has achieved a higher rank by satisfying a predetermined condition, takes the time the rank was achieved as a reference time and converts times in each purchase history to relative times and which, for a purchase history of a target customer who has not attained the rank, takes the time when an analysis target is designated as a reference time, and converts times in each purchase history to relative times; and
a behavior history analysis unit which determines whether a behavior history of the target customer is included in a behavior history of the model customer, based on each relative time of the behavior history with which each purchase history of the model customer has been associated and each relative time of the behavior history with which each purchase history of the target customer has been associated.

2. The data management apparatus according to claim 1, comprising:
a purchase history segmentation unit which segments data of items included in the purchase history of the model customer and segments data of items included in the purchase history of the target customer,
wherein the behavior history analysis unit determines whether the behavior history of the target customer is included in the behavior history of the model customer based on the model customer data which has been segmented by the purchase history segmentation unit and the target customer data which has been segmented by the purchase history segmentation unit.

3. The data management apparatus according to claim 1, comprising:
a purchase history aggregation unit which aggregates data of items included in the purchase history of the model customer and aggregates data of items included in the purchase history of the target customer,
wherein the behavior history analysis unit determines whether the behavior history of the target customer is included in the behavior history of the model customer based on the model customer data which has been aggregated by the purchase history aggregation unit and the target customer data which has been aggregated by the purchase history aggregation unit.

4. The data management apparatus according to claim 1,
wherein the behavior history analysis unit identifiably outputs a part, of the behavior history of the model customer, in which the behavior history of the target customer is included and a part in which the behavior history of the target customer is not included.

5. The data management apparatus according to claim 1,
wherein, when there exist a plurality of the model customer, the behavior history analysis unit adds a nonmatching behavior as a node for each behavior in the behavior history of the plurality of model customers, connects an arc to the added node to indicate each behavior history of the plurality of models, and displays a screen which shows that each node has been associated by an arc, on a screen display unit.

6. The data management apparatus according to claim 5,
wherein the behavior history analysis unit highlights the nodes among the added nodes for which there is a match between a behavior in the behavior history of the plurality of model customers and a behavior in the behavior history of the target customer.

7. A data management system, comprising:
a relative time conversion unit which, for a purchase history of a model customer who has achieved a higher rank by satisfying a predetermined condition, takes the time the rank was achieved as a reference time and converts times in each purchase history to relative times and which, for a purchase history of a target customer who has not attained the rank, takes the time when an analysis target is designated as a reference time, and converts times in each purchase history to relative times; and
a behavior history analysis unit which determines whether a behavior history of the target customer is included in a behavior history of the model customer, based on each relative time of the behavior history with which each purchase history of the model customer is associated and each relative time of the behavior history with which each purchase history of the target customer has been associated.
